(19) United States
(12) Patent Application Publication
(10) Pub. No.: US 2009/0010639 A1
(43) Pub. Date: Jan. 8, 2009

(54) Photo Processing Device, Cartridge, and Control Method for Photo Processing Device

(75) Inventor: Yoshihiro Fujita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/885,585

(22) PCT Filed: Feb. 21, 2006
(86) PCT No.: PCT/JP06/03082

§ 371 Date: Sep. 4, 2007

(30) Foreign Application Priority Data
Mar. 3, 2005 (JP) 2005-059733

(51) Int. Cl. G03D 13/00

(52) U.S. Cl. 396/571; 396/564

(57) ABSTRACT

RFID tag to which predetermined information is written in advance is added to a replenisher cartridge, and the information is read from the RFID tag when the replenisher cartridge is loaded in a photo processing device. Whether or not a loaded replenisher cartridge is a genuine product is judged based on whether or not the predetermined information is written in the tag. When it is judged, based on whether or not the predetermined information is in the tag, that the loaded replenisher cartridge is not the genuine product, a processing speed (carrying speed of photographic paper) is reduced from normal level and at the same time a supply quantity of the replenisher to a processing solution tank is increased from a normal level. This avoids significant reduction in the photo processing performance and enables non-genuine replenisher cartridges to be also used.

### TECHNICAL FIELD

The present invention relates to a photo processing device, cartridge, and a control method for photo processing device, and in particular, relates to a photo processing device which processes a recording material on which an image is recorded with a processing solution in a processing solution tank and to which a cartridge enclosing a replenisher to be supplied to the processing solution tank is detachably attached, a cartridge enclosing a replenisher which is loadable in a photo processing device, and a control method for photo processing device.

### BACKGROUND ART

Conventionally, the photo processing device is known, for visualizing a recorded latent image as an image by immersing sequentially in each processing solution such as a color developer, bleach fixing agent and rinse water, and subsequently drying, a photosensitive material such as photo film on which an object is recorded as a latent image by camera, photographic paper on which an image recorded on a photo film is exposure-recorded as a latent image, and the like. In such a type of photo processing device, the mode enters the mainstream, in which each replenisher to be supplied to each processing solution tank is supplied in a state enclosed in a cartridge for simplifying a supplying operation and for preventing the replenisher to be input by mistake, and the replenisher in the cartridge is automatically mixed and automatically supplied to each processing solution tank by loading the cartridge in the photo processing device.

On the other hand, the photo processing device and the processing solution used in the photo processing device are improved and developed such that a sufficient photo processing performance may be obtained in a speedy processing condition requiring a small quantity of replenisher, and each time a new model of the photo processing device is developed, an exclusive processing solution is newly developed for achieving a speedy processing requiring a small quantity of replenisher. An exclusive replenisher corresponding to the exclusive processing solution is supplied in a state enclosed in the cartridge, so that various cartridges in which different replenisher is enclosed are available in the market. Therefore, there is a possibility in which the cartridge is wrongly loaded in the photo processing device. If other replenisher is supplied to the photo processing device, which is designed on an assumption that the exclusive replenisher is supplied, the photo processing performance may be significantly reduced, for example, yellow density of the image visualized on the photosensitive material is significantly lowered and defective desilverization occurs.

In connection with above, Japanese Patent Application Laid-Open (JP-A) No. 2004-226790 discloses the technology for determining whether or not the loaded replenisher cartridge is inappropriate by registering the remaining quantity of the replenisher in the RFID tag attached to the replenisher cartridge and updating the remaining quantity registration value each time the remaining quantity of the replenisher in the replenisher cartridge changes in a state in which the replenisher cartridge is loaded in the photo processing device, and at the same time, by judging whether or not the deviation of the remaining quantity registered in the RFID tag and the actual remaining quantity is within the predetermined value when the new replenisher cartridge is loaded to the photo processing device.

And, Japanese Patent Application Laid-Open (JP-A) No. 2004-93692 discloses the technology in which the version information is written in each IC memory unit attached to the photographic paper container and the replenisher container, and the photo processing device reads the version information with the information reader provided to the loading portion, judges whether or not the combination of the read version information matches the processing condition formulation, and when the combination matches, controls the carrying speed and the processing temperature to the optimal condition and when not, gives the alarm.

And, Japanese Patent Application Laid-Open (JP-A) No. 2005-10196 discloses the technology in which the container ID information is written in the IC tag attached to the replenisher container, and the photo processing device allows the additional supply of replenisher from the replenisher container to the replenisher tank when the replenisher container is judged to match the replenisher tank of which timing to add the replenisher is coming, based on the container ID information read from the IC tag of the replenisher container.

As described above, the technology in which the IC tag or the like is attached to the genuine cartridge and the predetermined information is recorded in the IC tag or the like, the predetermined information is read from the IC tag or the like attached to the cartridge loaded in the photo processing device, thereby determining whether or not the loaded cartridge is the appropriate cartridge, and controlling the processing condition to the photosensitive material has been already suggested.

### DISCLOSURE OF THE INVENTION

### Subject to be Addressed by the Invention

However, in all of the above-described technologies, the error occurs when the IC tag or the like is not attached to the cartridge loaded in the photo processing device, and when the predetermined information is not recorded in the IC tag or the like attached to the cartridge, and the replenisher in the loaded cartridge is not used to be supplied to the processing solution tank. Therefore, there is a problem that the older type cartridge to which the IC tag or the like is not attached and the cartridge manufactured by different manufacturer cannot be used. On the other hand, it is not preferred to use the replenisher in the cartridge to be supplied to the processing solution tank without restriction regardless of whether or not the cartridge loaded in the photo processing device is the genuine product since the photo processing performance may be significantly reduced as described above.

The present invention is made in consideration of the above fact, and provides the photo processing device capable of using the non-genuine cartridge and of preventing the significant reduction in the photo processing performance when the non-genuine cartridge is used, the cartridge, and the control method for photo processing device.

### Measures for Addressing the Subject

The inventor of the present invention has focused on the fact that the performance difference between the genuine replenisher and other replenishers becomes significant with processing conditions such as mainly the processing speed and the supply quantity, and has conceived to maintain the photo processing performance at a certain level even when the cartridge loaded in the photo processing device is not the genuine product (when the cartridge in which the replenisher other than the genuine replenisher is enclosed is loaded) by making the processing speed slower than and making the supply quantity to the processing solution tank larger than the normal processing condition, thereby making the present invention.

A first aspect of the present invention is a photo processing device comprising: a detachable cartridge enclosing a replenisher to be supplied to the processing solution in the processing solution tank; a determination portion that determines whether or not first predetermined information is recorded at the loaded cartridge; and a control portion that, when the determination portion determines that the first predetermined information is not recorded at the cartridge, performs either or both of a first control that makes a processing speed of the recording material slower than when a cartridge is loaded at which the first predetermined information is recorded, and a second control that makes a supply quantity of the replenisher to the processing solution tank larger than when the cartridge is loaded at which the first predetermined information is recorded.

By recording the first predetermined information in the cartridge (genuine cartridge), the photo processing device operates with the normal processing speed and with the normal supply quantity to the processing solution tank when the genuine cartridge is loaded, so that the original photo processing performance of the photo processing device can be provided. Meanwhile, although the information indicating the manufacturer of the cartridge and the type of the replenisher enclosed in the cartridge, for example, may be used as the first predetermined information, any other information (for example, information indicating that the manufacturer of the cartridge guarantees the quality of the replenisher) may be applicable.

And, in a case in which the cartridge in which the first predetermined information is not recorded (non-genuine cartridge) is loaded, either or both of the first control that makes the processing speed of the recording material slower than when the cartridge is loaded in which the first predetermined information is recorded, and the second control that makes the supply quantity of the replenisher to the processing solution tank larger than when the cartridge is loaded at which the first predetermined information is recorded, is performed. Thereby, it becomes possible to prevent the reduction in the photo processing performance, such as the significant reduction in the image quality, so that it becomes possible to use the photo processing device according to an aspect of the present invention with the non-genuine cartridge loaded therein.

In the aspect described above, the control portion may perform either or both of the first control and the second control depending on a length of storage period of the replenisher, which is identified based on second predetermined information recorded at the cartridge by which the length of storage period of the replenisher enclosed can be identified.

There is a case that the performance of the replenisher gradually changes depending on the length of the time period that has elapsed since the manufacture thereof (the length of storage period), and by performing the control, it becomes possible to prevent the variance of photo processing performance depending on the length of the storage period of the replenisher enclosed in the cartridge.

And the cartridge may be configured such that information may be written thereon, the photo processing device may further be provided with a writing portion for writing third predetermined information to the loaded cartridge, the determination portion may further determine whether or not the third predetermined information is recorded at the cartridge, and the control portion may perform either or both of the first control and the second control when the determination portion determines that the third predetermined information is recorded at the cartridge.

After the genuine cartridge is used, in a case in which the cartridge is reused with the non-genuine replenisher enclosed therein, information by which it can be determined that this is the cartridge enclosing the non-genuine replenisher is written in the cartridge as third predetermined information. By performing either or both of the first control and the second control based on the third predetermined information, it becomes possible to prevent the reduction in the photo processing performance such as the significant reduction in the image quality.

In the above-described aspect, the control portion may further perform a third control that changes a temperature of the processing solution in the processing solution tank.

And the first control may be selected from a plurality of predetermined processing speeds, and the second control may be selected from a plurality of predetermined supply quantity of the replenisher.

Thereby, it also becomes possible to prevent the reduction in the photo processing performance, such as the significant reduction in the image quality, and it becomes possible to use the photo processing device according to an aspect of the present invention with the non-genuine cartridge loaded therein.

Meanwhile, in the above-described aspect, the first predetermined information may be recorded in the cartridge in a form of a barcode or the like, and in this case, the determination portion may be configured to read the barcode recorded in the cartridge by a barcode reader and determine whether or not the first predetermined information is recorded based on the result of the reading of the barcode. However, in general, the barcode is easy to be faked (imitated), and when the non-genuine cartridge is loaded in which the barcode indicating the first predetermined information is recorded, it is not possible to identify that the cartridge is not the genuine product, and the first control and the second control are not performed by the control portion, so that there is the possibility that the reduction in the photo processing performance, such as the significant reduction in the image quality, occurs. And there is also a defect that it is difficult to additionally record information in the barcode, as will be described later.

Considering this, it is preferred that the first predetermined information is recorded at a recording device attached to the cartridge, and the determination portion is provided with a reading portion configured to read the information recorded at the recording device attached to the loaded cartridge, and makes the reading portion read the information recorded at the reading device attached to the cartridge, and determines whether or not the first predetermined information is recorded based on a result of the reading. As the recording device described above, an RFID (Radio Frequency Identification) tag capable of reading information by the radio transmission is preferable, and in this case, the reading portion may be composed of the IC tag head. By using the recording device, the difficulty of faking (imitating) increases compared with the mode in which the first predetermined information is recorded in the cartridge in the form of the barcode, and it is possible to prevent the cartridge from being wrongly identified as the genuine product, thereby significantly decreasing the probability of the reduction in the photo processing performance.

Further, second predetermined information, by which a length of storage period of the replenisher enclosed in the cartridge can be identified, may be recorded at the recording device attached to the cartridge when manufacturing the cartridge, when enclosing the replenisher in the cartridge, or when shipping the cartridge. The control portion may perform at least either or both of the first control and the second control by identifying the length of storage period of the replenisher based on the second predetermined information read from the recording device attached to the cartridge by the reading portion. By performing the control, it becomes possible to prevent the variance of the photo processing performance depending on the length of the storage period of the replenisher enclosed in the cartridge.

As the second predetermined information, information indicating the manufacture date or a storage limit of the replenisher may be applied, for example. When using information indicating the manufacture date of the replenisher as the second predetermined information, the length of the storage period of the replenisher can be identified by calculating the time period that has elapsed since the manufacture date. When information indicating the storage limit of the replenisher is used, the length of the storage period of the replenisher can be identified by calculating the time period until the storage limit and subtracting the calculated time period from the time period between the manufacture of the replenisher and the storage limit.

Further, the control portion may perform either or both of the second control and the third control depending on the length of storage period of the replenisher identified based on the second predetermined information read from the recording device attached to the loaded cartridge by the reading portion. Thereby, it also becomes possible to prevent the variance of the photo processing performance depending on the length of the storage period of the replenisher enclosed in the cartridge.

In the above-described aspect, the recording device attached to the cartridge may be configured such that information may be written thereon, and the photo processing device may further be provided with a writing portion for writing third predetermined information to the recording device attached to the loaded cartridge. It is preferable that the determination portion also determines whether or not the third predetermined information is recorded at the recording device attached to the loaded cartridge, and that the control portion also performs either or both of the first control and the second control when the determination portion determines that the third predetermined information is recorded at the recording device of the cartridge.

There is a case in which after the genuine cartridge is loaded in the photo processing device once and the genuine replenisher is used to be supplied to the processing solution tank, the cartridge is removed from the photo processing device and reused with the non-genuine replenisher supplied thereto. In a case in which the cartridge is loaded again in the photo processing device, the cartridge is identified to be the genuine cartridge, because the first predetermined information is recorded in the recording device. There is a possibility that the reduction in the photo processing performance, such as the significant reduction in the image quality of the image, may occur, because the first control and the second control are not performed by the control portion even though the replenisher enclosed in the cartridge is not the genuine replenisher. However, it is possible to detect that this is the cartridge to which the non-genuine replenisher is supplied, by the third predetermined information, and it is possible to prevent the reduction in the photo processing performance by performing either or both of the first control and the second control by the control portion.

A second aspect of the present invention is a cartridge that is configured to be loaded at the photo processing device of the first aspect of the present invention, in which cartridge a genuine replenisher to be supplied to the processing solution in the processing solution tank is enclosed, and at which cartridge the first predetermined information is recorded in advance.

Since the first predetermined information is recorded in the above-described cartridge, when the cartridge is loaded in the photo processing device of an aspect of the present invention, the photo processing device operates with a normal processing speed and a normal supply quantity to the processing solution tank, so that an original photo processing performance of the photo processing device can be provided.

A third aspect of the present invention is a cartridge that is configured to be loaded at the photo processing device of the first aspect of the present invention, in which cartridge the genuine replenisher to be supplied to the processing solution in the processing solution tank is enclosed, and to which cartridge the recording device is attached.

Since it is possible to record various information in the recording device attached to the cartridge, the reduction in the photo processing performance, such as the significant reduction in the image quality of the image, can be prevented by controlling at least one of the processing speed, the supply quantity of the replenisher, and the temperature in the processing solution tank, depending on the type of the cartridge based on the information in the recording device.

A fourth aspect of the present invention is a method for controlling a photo processing device comprising: determining whether or not first predetermined information is recorded at a detachable cartridge in which a replenisher to be supplied to the processing solution in the processing solution tank is enclosed, and when it is determined that the first predetermined information is not recorded at the cartridge, performing either or both of a first control that makes a processing speed of the recording material slower than when a cartridge is loaded at which the first predetermined information is recorded, and a second control that makes a supply quantity of the replenisher to the processing solution tank larger than when a cartridge is loaded at which the first predetermined information is recorded.

In the above-described aspect, whether or not the first predetermined information is recorded may be determined by adding a recording device to the cartridge, recording the first predetermined information in the recording device, and reading the information in the recording device.

Thereby, it becomes possible to use the cartridge to which the genuine replenisher is supplied and the cartridge to which the non-genuine replenisher is supplied, and the reduction in the photo processing performance, such as the significant reduction in the image quality of the image, can be prevented, even though the cartridge to which the non-genuine replenisher is supplied is used.

Further, second predetermined information, by which a length of storage period of the replenisher enclosed in the cartridge can be identified, may be recorded at a recording device when manufacturing the cartridge, when enclosing the replenisher in the cartridge, or when shipping the cartridge, and either or both of the first control and the second control may be performed depending on the length of storage period of the replenisher, which is identified based on the second predetermined information in the recording device.

Thereby, it becomes possible to prevent the variance of the photo processing performance depending on the length of the storage period of the replenisher.

And, the recording device attached to the cartridge may be configured such that information may be written thereon, and the third predetermined information may be written at the recording device. Whether or not the third predetermined information is recorded at the recording device attached to the loaded cartridge may be determined, and either or both of the first control and the second control may be performed when it is determined that the third predetermined information is recorded.

Also in a case in which the genuine cartridge is reused with the non-genuine replenisher enclosed therein, it is possible to prevent the reduction in the photo processing performance, such as the significant reduction in the image quality of the image, by detecting that this is the non-genuine replenisher based on the third predetermined information and performing either or both of the first control and the second control.

### BRIEF DESCRIPTION OF THE DRAWINGS

FIG. 1 A schematic configuration diagram of a photo processing device according to the embodiment.

FIG. 2 A schematic configuration diagram of a processor portion of the photo processing device.

FIG. 3 A perspective view showing a replenisher cartridge and a loading portion.

FIG. 4 A cross-sectional view showing a structure of an opening portion of the replenisher cartridge.

FIG. 5 A block diagram showing a schematic configuration of an RFID tag and an IC tag head.

FIG. 6 A flowchart showing a processing when loading cartridge according to a first embodiment.

FIG. 7 A flowchart showing a processing when loading cartridge according to a second embodiment.

### BEST MODE FOR CARRYING OUT THE INVENTION

Hereinafter, one example of an embodiment of the present invention will be described in detail with reference to the drawings.

### First Embodiment

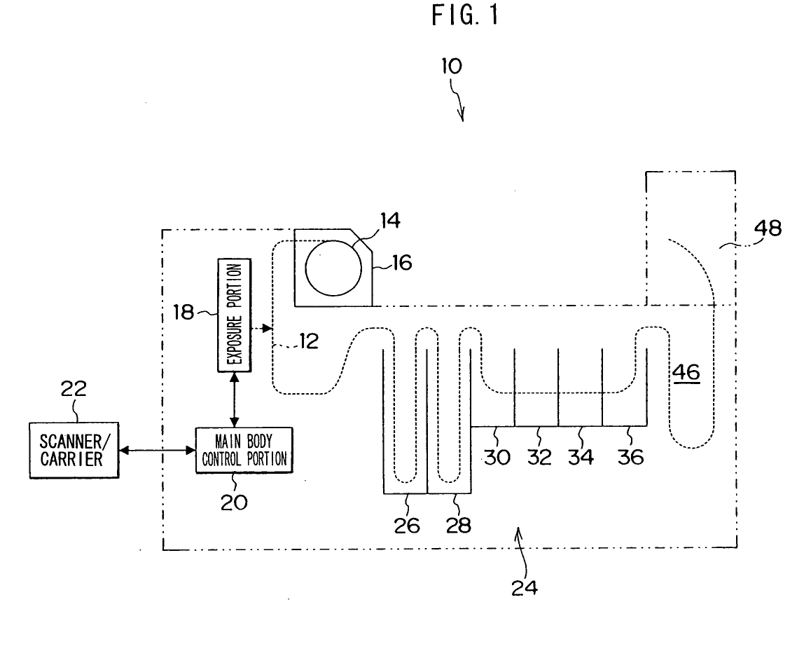

FIG. 1 shows a photo processing device 10 according to the embodiment. The photo processing device 10 is a device for exposure-recording an image on photographic paper and performing a processing such as development to the photographic paper, thereby making a photo print. A magazine 16 storing a photographic paper roll 14 obtained by rolling lengthy photographic paper 12 into a roll around a core can be loaded in the device. The photo processing device 10 is provided with an exposure portion 18, and the exposure portion 18 is configured to exposure-record the image on the photographic paper 12 by drawing the lengthy photographic paper 12 from the photographic paper roll 14 and scan-exposing the photographic paper 12 with a laser beam modulated depending on the image to be recorded on the photographic paper 12.

The photo processing device 10 is provided with a main body control portion 20 for controlling a motion of each portion of the photo processing device 10. A scanner/carrier 22 for reading the image recorded on an original such as a photo film carried by the carrier and outputting a read result as an image data can be connected to the main body control portion 20. In a case in which the scanner/carrier 22 is connected to the main body control portion 20, the image data used to modulate the laser beam in the exposure portion 18 is supplied from the scanner/carrier 22 through the main body control portion 20. Meanwhile, the image data used for modulating may be the image data obtained by photographing an object by a digital still camera (DSC).

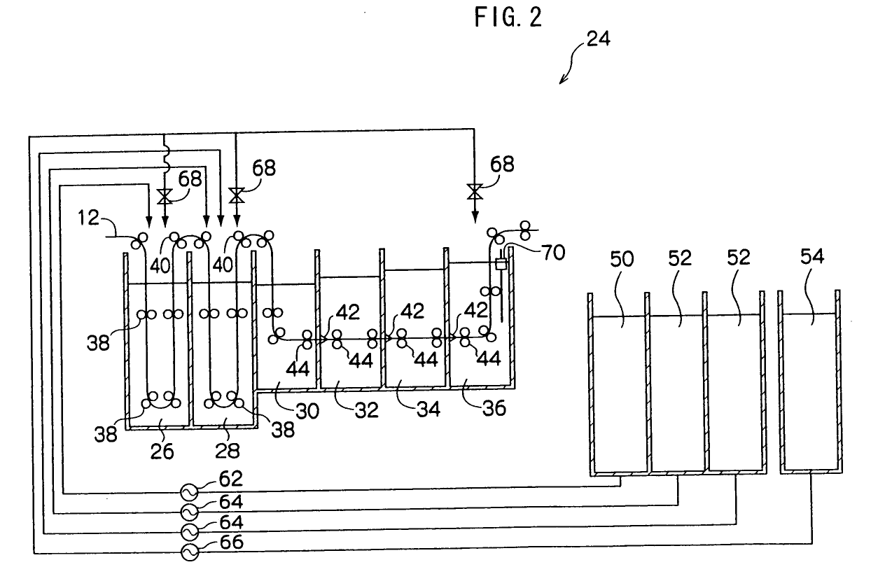

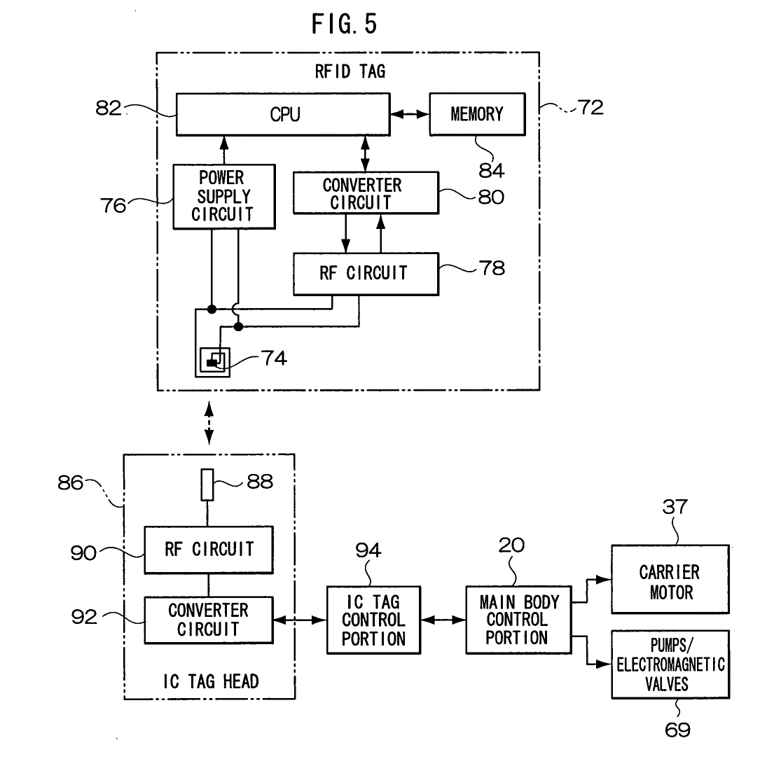

And, the photo processing device 10 is provided with a processor portion 24. A color developer tank 26 in which a color developer is reserved, a bleach fixing agent tank 28 in which a bleach fixing agent is reserved, and first rinse water tank 30, second rinse water tank 32, third rinse water tank 34 and fourth rinse water tank 36 in each of which rinse water is reserved, are sequentially disposed in a horizontal direction in the processor portion 24. Each of the color developer tank 26 and the bleach fixing agent tank 28 is provided with a carrier roller 38 (refer to FIG. 2) for carrying the photographic paper 12 in a state immersed in processing solution by being rotary-driven by a drive force transmitted from a carrier motor 37 (refer to FIG. 5), and the photographic paper 12 is carried in the color developer, then sent from the color developer tank 26 to the bleach fixing agent tank 28 by a carrier roller 40, also rotary-driven by a drive force of the carrier motor 37, and carried in the bleach fixing agent in the bleach fixing agent tank 28.

And as shown in FIG. 2, each dividing wall between the rinse water tanks 30, 32, 34 and 36 has a slit through which the photographic paper 12 passes. In the vicinity of the slit, a pair of blades 42 formed of an elastic body are provided so as to abut each other, and the photographic paper 12 can pass between the pair of blades 42. Each of the rinse water tanks 30, 32, 34 and 36 is provided with a carrier roller 44 for carrying the photographic paper 12 in the horizontal direction by being rotary-driven by the drive force transmitted from the carrier motor 37, and the photographic paper 12 is carried in the rinse water from the first rinse water tank 30 to the fourth rinse water tank 36 by sequentially passing between the pair of blades 42.

As shown in FIG. 1, a drying portion 46 is provided on a downstream side of the fourth rinse water tank 36, and the photographic paper 12 of which the rinse processing in the fourth rinse water tank 36 is completed is sent from the fourth rinse water tank 36 to the drying portion 46, and a surface thereof is dried by being supplied a hot air generated by a fan and a heater not shown. And a cutter/sorter 48 is disposed on a downstream side of the drying portion 46, and the photographic paper 12 of which surface is dried at the drying portion 46 is cut into frames by the cutter/sorter 48 and sorted by individual orders. Meanwhile, as shown in FIG. 5, the carrier motor 37 is connected to the main body control portion 20 and on/off of the drive of the carrier motor 37 and a rotational speed of a driving shaft are controlled by the main body control portion 20. The carrying speed of the photographic paper 12 carried in the photo processing device 10 varies depending on the rotational speed of the driving shaft of the carrier motor 37.

Next, supply of a replenisher to each processing solution tank of the processor portion 24 will be described. As shown in FIG. 2, a developer replenisher tank 50 in which a color developer replenisher is reserved, a bleach fixing agent replenisher tank 52 in which a bleach fixing agent replenisher is reserved, and a water tank 54 in which water is reserved are disposed in the processor portion 24. Meanwhile, there are two types of bleach fixing agent replenishers, and two bleach fixing agent replenisher tanks 52 corresponding to the two types of bleach fixing agent replenishers are provided.

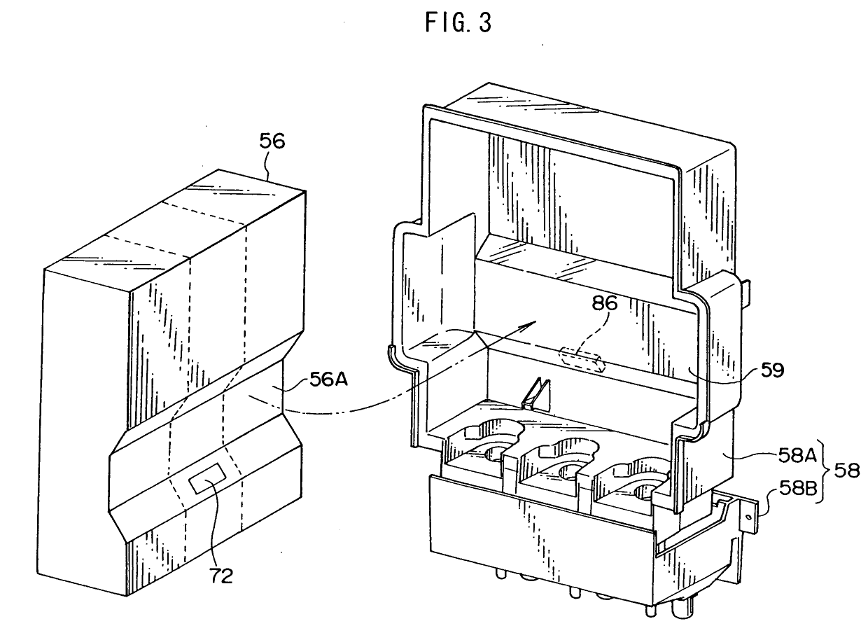

The color developer replenisher and the bleach fixing agent replenisher are supplied in a state in which they are enclosed in a replenisher cartridge 56 shown in FIG. 3. The replenisher cartridge 56 is substantially the shape of a rectangular parallelepiped as a whole, and has a concave portion 56A which is formed at a vertically intermediate portion from one end to the other end in a width direction thereof. An inner portion of the replenisher cartridge 56 is partitioned into three liquid chambers as indicated by broken lines in FIG. 3, and each of the color developer replenisher and the bleach fixing agent replenishers (two types of liquids) are enclosed in different liquid chambers, respectively.

The processor portion 24 shown in FIG. 1 is provided with a cartridge loading portion 58 for loading the replenisher cartridge 56 (refer to FIG. 3). The cartridge loading portion 58 is exposed by opening a door (not shown) on a side surface of the photo processing device 10, and then the replenisher cartridge 56 can be loaded therein. Meanwhile, the door is provided with an interlock mechanism (not shown) for preventing the door from being opened during a time period other than when replacing the replenisher cartridge 56.

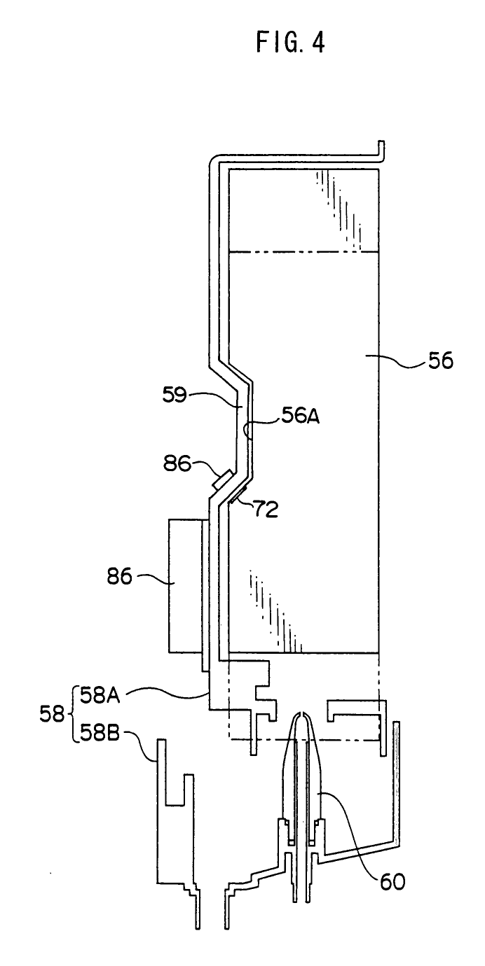

Although not shown, the replenisher cartridge 56 is provided with replenisher outlets each corresponding to each of the liquid chambers, respectively, in a bottom portion thereof, and each of the replenisher outlets is closed by a cap. The replenisher cartridge 56 is loaded in the cartridge loading portion 58 in a state in which the bottom portion thereof faces downwards. As shown in FIG. 4, the cartridge loading portion 58 is composed of a cartridge receiver 58A for supporting the loaded replenisher cartridge 56 and a liquid receiver portion 58B for guiding the replenisher discharged from the replenisher cartridge 56 to a corresponding replenisher tank.

A convex portion 59 corresponding to the concave portion 56A of the replenisher cartridge 56 is formed in the cartridge receiver 58A. The convex portion 59 positions the replenisher cartridge 56 on a fixed position by being mated with the concave portion 56A in a state in which the replenisher cartridge 56 is loaded. And, the cartridge receiver 58A is moved up and down by an up-and-down drive portion not shown.

And, an opening nozzle 60 for opening the cap closing the replenisher outlets of the replenisher cartridge 56 stands erect in the liquid receiver portion 58B. When the cartridge receiver 58A is moved down to the lower limit position in a state in which the loaded replenisher cartridge 56 is supported by the cartridge receiver 58A, the cap of each of the replenisher outlets of the replenisher cartridge 56 is opened by the opening nozzle 60, and with the opening of the cap, the replenisher in each of the liquid chambers is discharged from the replenisher outlets and the discharged replenishers are guided and supplied to the corresponding replenisher tank through the liquid receiver portion 58B.

As shown in FIG. 2, the color developer replenisher in the developer replenisher tank 50 is supplied to the color developer tank 26 by a pump 62, the bleach fixing agent in the bleach fixing agent replenisher tank 52 is supplied to the bleach fixing agent tank 28 by a pump 64, and the water in the water tank 54 is supplied to the color developer tank 26, the bleach fixing agent tank 28 and the fourth rinse water tank 36 by a pump 66. Meanwhile, electromagnetic valves 68 are provided at a midpoint of each tubing from the pump 66 to the color developer tank 26, to the bleach fixing agent tank 28 and to the fourth rinse water tank 36. As shown in FIG. 5, each of the pumps 62, 64 and 66 and the electromagnetic valves 68 is connected to the main body control portion 20, respectively (in FIG. 5, a reference numeral “69” is assigned to the pumps 62, 64 and 66 and the electromagnetic valves 68 and they are represented as “pumps/electromagnetic valves”), and on/off of the pumps 62, 64 and 66 and the electromagnetic valves 68 (supply of each replenisher from each replenisher tank to each processing solution tank) is controlled by the main body control portion 20.

And as shown in FIG. 2, the water is supplied to the fourth rinse water tank 36 on the most downstream side of the rinse water tanks in the embodiment, and when the rinse water is supplied to the fourth rinse water tank 36, the supplied rinse water sequentially overflows to the rinse water tank on an upstream side, and finally, discharged from the first rinse water tank 30 to a waste solution tank (not shown). Therefore, the first to fourth rinse water tanks are made in a so-called cascade state in which cleanness of the rinse water is higher in the rinse water tank on more downstream side. And, the fourth rinse water tank 36 is provided with a liquid concentration detection sensor 70. The liquid concentration detection sensor 70 is provided with a pair of electrodes disposed so as to be apart from each other, and is configured to use the pair of electrodes by immersing them in the processing solution (rinse water), and an output voltage varies depending on a liquid component concentration of the rinse water (for example, a concentration of iron contained in the bleach fixing agent).

Meanwhile, as shown in FIG. 3, the concave portion 56, formed on the replenisher cartridge 56 according to the embodiment has a substantially chevron-shaped cross-section, obtained by tilting a side surface of the concave portion 56 against a bottom surface (top surface) and a side surface of the replenisher cartridge 56. An RFID tag 72 is attached to the side surface of the concave portion 56. As shown in FIG. 5, the RFID tag 72 according to the embodiment is integrated with an antenna 74, and is composed of a power supply circuit 76, an RF circuit 78, a converter circuit 80, a CPU 82 and a memory 84. The power supply circuit 76 forms a resonance circuit together with the antenna 74, and is configured to accumulate electrical power in a condenser not shown by a mutual induction effect, when an electric wave having a specific frequency is received by the antenna 74, and to rectify the accumulated electrical power and supply the electrical power to the CPU 82 and other circuit. The CPU 82 controls the motion of each portion of the RFID tag 72.

And the RF circuit 78 amplifies the signal output from the antenna 74 and outputs the signal to the converter circuit 80 when the electric wave is received by the antenna 74, and amplifies the signal and supplies the signal to the antenna 74 when the signal is input from the converter circuit 80. The converter circuit 80 demodulates the signal input from the RF circuit 78, outputs the digital data obtained by demodulation to the CPU 82, and modulates the carrier wave signal by the digital data input from the CPU 82 and outputs the modulated signal to the RF circuit 78. And, as the memory 84, a nonvolatile memory (for example, a flush memory or the like) capable of reading and writing the information may be used. Meanwhile, the above-described RFID tag 72 corresponds to the recording device described in Claims.

On the other hand, an IC tag head 86 provided with a function to perform a radio communication with the RFID tag 72 is disposed on a position opposing to the RFID tag 72 (that is to say, on a side surface of the convex portion 59 of the cartridge receiver 58A) in a state in which the replenisher cartridge 56 is loaded (refer also to FIGS. 3 and 4). The IC tag head 86 is provided with an antenna 88, an RF circuit 90 and a converter circuit 92, and is connected to the IC tag control portion 94.

Meanwhile, the replenisher cartridge 56 loaded in the cartridge loading portion 58 is positioned on a substantially fixed position by the concave portion 56A mating with the convex portion 59. And the RFID tag 72 is attached to the side surface of the concave portion 56A of the replenisher cartridge 56, and the IC tag head 86 is disposed on the side surface of the convex portion 59 of the cartridge receiver 58A. By this configuration, a space between the RFID tag 72 and the IC tag head 86 becomes very small and fixed in a state in which the replenisher cartridge 56 is loaded in the cartridge loading portion 58, so that certainty of the communication between the RFID tag 72 and the IC tag head 86 is improved.

Meanwhile, although the space between the RFID tag 72 and the IC tag head 86 is made very small in a state in which the replenisher cartridge 56 is loaded in the cartridge loading portion 58, on the ground that the radio communication between the RFID tag 72 and the IC tag head 86 is performed in a communication system of which communication distance is relatively short (for example, an electromagnetic coupling type or the like) in the embodiment, the space between the RFID tag 72 and the IC tag head 86 can be made larger by adopting the communication system of which communication distance is longer (for example, a microwave type or an optical type) as the radio communication between the RFID tag 72 and the IC tag head 86.

The RF circuit 90 amplifies a signal output from the antenna 88 and outputs the signal to the converter circuit 92 when the electric wave is received by the antenna 88, and amplifies the signal and supplies the signal to the antenna 88 when the signal is input from the converter circuit 92. And, the converter circuit 92 demodulates the signal input from the RF circuit 90 and outputs the digital data obtained by the demodulation to the IC tag control portion 94, and modulates the carrier wave signal by the digital data input from the IC tag control portion 94 and outputs the modulated signal to the RF circuit 90. The IC tag control portion 94 is connected to the main body control portion 20.

Next, as an operation of the first embodiment, first, manufacture and supply of the replenisher cartridge 56 will be described. In a manufacturing facility in which the replenisher cartridge 56 is manufactured, the color developer replenisher and bleach fixing agent replenishers (two types of liquids) are enclosed in the three liquid chambers of the empty bottle of the replenisher cartridge 56, respectively, and the RFID tag 72 is added to the bottle of the replenisher cartridge 56. And on a manufacturing line of the replenisher cartridge 56 in the manufacturing facility, a writing device capable of writing information to the RFID tag 72 by the radio communication is disposed, and the writing device is composed of the IC tag head 86. By the writing device, type information for identifying the type of the replenisher cartridge 56, and information such as a manufacture date of the replenisher and a valid date (storage limit) of the enclosed replenisher are written in the RFID tag 72. Meanwhile, after writing the information in the RFID tag 72, the RFID tag 72 in which the information is written may be attached to the replenisher cartridge 56.

The type information described above corresponds to first predetermined information described in Claims, and specifically, although the information indicating the manufacturer of the replenisher cartridge 56 and the type of the replenisher enclosed in the replenisher cartridge can be used, any information indicating that the replenisher enclosed in the replenisher cartridge 56 is the genuine replenisher is suffice, and any other information such as the information indicating that the manufacturer of the cartridge guarantees the quality of the replenisher, for example, can be adopted. And, the information indicating the valid date of the replenisher corresponds to second predetermined information described in Claims.

After the RFID tag 72 is attached to the replenisher cartridge 56 and the information is written in the RFID tag 72, the replenisher cartridge 56 is stored in the manufacturing facility until shipment. Further, the replenisher cartridge 56 is shipped from the manufacturing facility in accordance with an order or the like from a customer who owns the photo processing device 10. A replenisher cartridge 56 delivered to the customer is stored until it becomes necessary to load the replenisher cartridge 56 into the photo processing device 10.

When it becomes necessary to supply the replenisher to the replenisher tank of the photo processing device 10 of the customer, the customer brings the stored new replenisher cartridge 56 out and notifies the photo processing device 10 of replacing the replenisher cartridge 56. Thereby, an operation in which the door on the side surface of the device is unlocked and is opened, the empty replenisher cartridge loaded in the cartridge loading portion 58 is removed, and the new replenisher cartridge 56 is loaded in the cartridge loading portion 58, then the door is closed is performed.

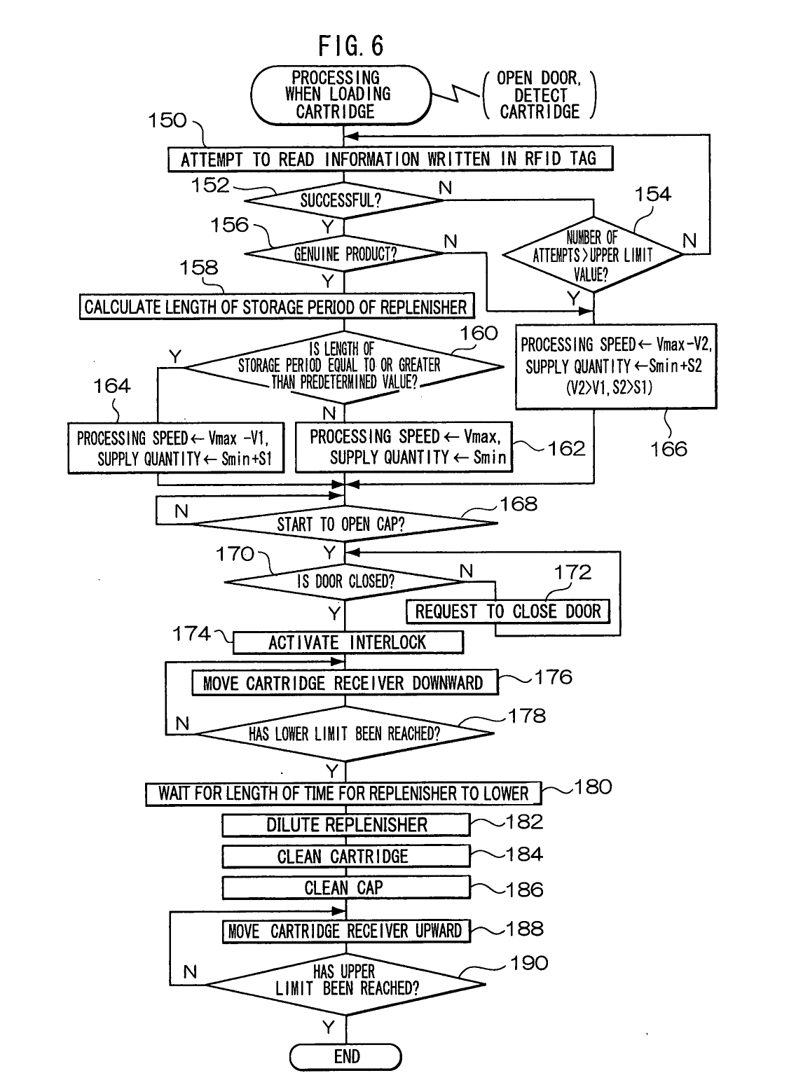

After the above-described operation, a processing when loading cartridge is performed in the main body control portion 20. Hereinafter, the processing when loading cartridge will be described with reference to the flowchart in FIG. 6.

In a step 150, reading of the information written in the memory 84 of the RFID tag 72, which is attached to the replenisher cartridge 5, is attempted by sending a predetermined electric wave (electric wave modulated based on predetermined information, which requires the RFID tag 72 to send the information written in the memory 84) from the antenna 88 of the IC tag head 86.

In a step 152, it is judged that whether or not the reading of the information written in the memory 84 is successful, based on whether or not the IC tag head 86 receives some information. If the result of judgment is NO, the procedure shifts to a step 154 and it is judged that whether or not the number of attempts of the reading of the information from the start of the processing when loading cartridge exceeds a predetermined upper limit value. If the result of judgment is also NO, the procedure returns to the step 150 and repeats the steps 150 to 154 until the result of judgment in step 152 or 154 becomes YES.

In a case in which the genuine RFID tag 72 is attached to the replenisher cartridge 56, when the predetermined electric wave sent from the antenna 88 of the IC tag head 86 is received by the antenna 74 of the RFID tag 72, first, the electric power is accumulated in a condenser not shown of the power supply circuit 76, the accumulated electric power is rectified and supplied to each circuit of the RFID tag 72, and the operation of each circuit of the RFID tag 72 is started.

Next, when the predetermined electric wave is received by the antenna 74, the signal output from the antenna 74 is amplified in the RF circuit 78, demodulated in the converter circuit 80, and the predetermined information is input to the CPU 82. The CPU 82 analyses the input information, and when identifying the information to be the predetermined information requiring sending of the information written in the memory 84, reads the various information written in the memory 84 from the memory 84 and outputs the information to the converter circuit 80. When the information is input from the CPU 82, the converter circuit 80 modulates the carrier wave signal by the input information and sends the signal to the RF circuit 78, and the RF circuit 78 amplifies the signal input from the converter circuit 80 and supplies the signal to the antenna 74.

Thereby, the electric wave modulated based on the information read from the memory 84 is sent from the antenna 74, and the electric wave is received by the antenna 88 of the IC tag head 86, amplified in the RF circuit 90, demodulated in the converter circuit 92 and input to the IC tag control portion 94 as information. And, due to a transfer of the information from the IC tag control portion 94 to the main body control portion 20, the result of judgment in the step 152 becomes YES and the procedure shifts to a step 156.

In a nonvolatile memory not shown incorporated in the main body control portion 20, the genuine type information corresponding to the genuine replenisher cartridge 56 (the replenisher cartridge 56 in which the genuine replenisher is enclosed) to be loaded in the photo processing device 10 is stored in advance. In the step 156, it is determined whether or not the replenisher cartridge 56 loaded this time in the cartridge loading portion 58 is the genuine product to be loaded in the photo processing device 10 by extracting the type information from the information read from the RFID tag 72, comparing the extracted type information with the genuine type information stored in the nonvolatile memory in advance, and determining whether or not both information is identical. Meanwhile, the step 156 together with the step 150 corresponds to a determination portion according to an aspect of the present invention, and the IC tag head 86 for reading the information from the RFID tag 72 corresponds to a reading portion described in Claims.

In a case in which the result of judgment in the step 156 is YES, the procedure shifts to a step 158, and the information indicating the manufacture date of the replenisher is extracted from the information read from the RFID tag 72, and a transitional period from the manufacture date indicated by the extracted information (the length of storage period of the replenisher enclosed in the replenisher cartridge 56 loaded this time) is calculated. And by comparing the calculated length of storage period with the predetermined value, it is judged whether or not the replenisher enclosed in the replenisher cartridge 56 loaded this time is in a state in which the predetermined time period or more has elapsed since the manufacture date.

In a case in which the result of judgment is NO, it is determined that the replenisher cartridge 56 loaded this time in the cartridge loading portion 58 is the genuine product, and that the replenisher enclosed in the replenisher cartridge 56 is in a fresh state in which the length of storage period is short, so that the procedure shifts to the step 162. A preset maximum speed Vmax is set as a processing speed V (carrying speed of the photographic paper 12 and a time during which the photographic paper 12 is immersed in the processing solution in each processing solution tank vary depending on the processing speed V) in the processor portion 24, and a preset minimum value Smin is set as a supply quantity S of each replenisher to be supplied to each processing solution tank (specifically, a proportional constant to be multiplied to a processing area of the photographic paper 12, in an operational expression calculating the supply quantity depending on the processing area of the photographic paper 12). Meanwhile, the maximum speed Vmax of the processing speed and the minimum value Smin of the supply quantity has a precondition that the genuine replenisher cartridge 56 is loaded in the photo processing device 10 and the replenisher enclosed in the replenisher cartridge 56 is fresh, and it is set such that a sufficient photo processing performance is obtained, the processing speed becomes as high as possible, and the supply quantity becomes as small as possible, under this precondition.

And, when the result of judgment in the step 160 is YES, it is determined that the replenisher cartridge 56 loaded this time in the cartridge loading portion 58 is the genuine product, however the replenisher enclosed somewhat loses its freshness, so that it is possible that the sufficient photo processing performance is not obtained if the processing speed is set to the maximum speed Vmax and the supply quantity is set to the minimum value Smin. Therefore, in a case in which the result of judgment in the step 160 is YES, the procedure shifts to a step 164, and a value obtained by subtracting a predetermined V1 from the maximum speed Vmax is set as the processing speed V, and a value obtained by adding a predetermined value S1 to the minimum value Smin is set as the supply quantity S.

On the other hand, in the above described steps 150 to 154, in a case in which the information cannot be read from the RFID tag 72 by attempting to read the information as many times as the upper limit value or more, or in a case in which the type information read from the RFID tag 72 is not identical to the genuine type information, it is determined that the replenisher cartridge 56 is not attached to the RFID tag 72 or that the genuine RFID tag 72 is not attached, so that this is not the genuine product. When the non-genuine replenisher is supplied, there may be a possible disadvantage that the photo processing performance is significantly reduced or the photo processing device 10 malfunctions, depending on the processing speed in the processor portion 24 and the supply quantity of each replenisher to each processing solution tank. Therefore, in a case in which the result of judgment in the step 154 is YES or the result of judgment in the step 156 is NO, the procedure shifts to a step 166, and a value obtained by subtracting a predetermined value V2 (V2>V1) from the maximum speed Vmax is set as the processing speed V, and a value obtained by adding a predetermined value S2 (S2>S1) to the minimum value Smin is set as the supply quantity S. Meanwhile, the steps 162, 164 and 166 correspond to the control portion according to an aspect of the present invention, and especially, the step 164 corresponds to the control portion described in Claims.

When the processing speed in the processor portion 24 and the supply quantity of each replenisher to each processing solution tank are set in the above-described step 162 or 164 or 166, the procedure shifts to a step 168. Until the processing when loading cartridge is performed again by loading the new replenisher cartridge 56 in the cartridge loading portion 58, the main body control portion 20 controls a rotational speed of the drive shaft of the carrier motor 37 so that the processing speed in the processor portion 24 (carrying speed of the photographic paper 12) is identical to the processing speed V set in the step 162 or 164 or 166. And, when calculating the supply quantity depending on the processing area of the photographic paper 12, the operational expression in which the supply quantity S is set as the proportional constant to be multiplied to the processing area of the photographic paper 12 is used and the supply quantity is calculated. The on/off of the pumps 62, 64 and 66 and the electromagnetic valves 68 is controlled such that the supply quantity of each replenisher from each replenisher tank to each processing solution tank is identical to the supply quantity obtained by using the operation expression.

Thereby, in a case in which the replenisher cartridge 56 loaded this time in the cartridge loading portion 58 is the genuine product and the replenisher enclosed in the replenisher cartridge 56 is fresh of which the length of storage period is short, the processing speed in the processor portion 24 becomes the maximum speed Vmax and the supply quantity of each replenisher from each replenisher tank to each processing solution tank becomes the minimum supply quantity corresponding to the minimum value Smin, so that the original performance of the photo processing device 10 is provided. And in a case in which the replenisher cartridge 56 is the genuine product, however, the replenisher somewhat loses its freshness, the processing speed in the processor portion 24 is somewhat (by the predetermined value V1) decreased from the maximum speed Vmax and the supply quantity is somewhat (by the supply quantity corresponding to the predetermined value S1) increased from the minimum supply quantity corresponding to the minimum value Smin, so that the reduction in the photo processing performance along with the loss of the freshness of the replenisher is prevented, and the image quality of the image recorded on the photographic paper 12 is not reduced.

And, even in a case in which the replenisher cartridge 56 loaded this time in the cartridge loading portion 58 is not the genuine product (in a case in which the replenisher cartridge 56 in which the non-genuine replenisher is enclosed is loaded), the operation of the photo processing device 10 is not stopped, and the replenisher enclosed in the replenisher cartridge 56 is supplied to the replenisher tank as will be described later. In this case, the processing speed in the processor portion 24 is clearly (by the predetermined value V2) decreased from the maximum speed Vmax and the supply quantity of each replenisher from each replenisher tank to each processing solution tank is clearly (by the supply quantity corresponding to the predetermined value S2) increased from the minimum supply quantity corresponding to the minimum value Smin, so that it becomes possible to use the non-genuine replenisher cartridge 56 (the replenisher cartridge 56 in which the non-genuine replenisher is enclosed), and the significant reduction in the photo processing performance such as the significant reduction in the image quality of image recorded on the photographic paper 12 is prevented.

Meanwhile, in a case in which the processing speed in the processor portion 24 is decreased from the maximum speed Vmax and the supply quantity of each replenisher to each processing solution tank is increased from the minimum supply quantity corresponding to the minimum value Smin as described above, it is preferred to display a message notifying the decreasing of the processing speed and the increasing of the supply quantity together with its reason (for example, “because the loaded replenisher cartridge is the non-genuine product” or the like) on a display portion of the photo processing device 10.

From the step 168, the replenisher enclosed in the replenisher cartridge 56 is supplied to each replenisher tank. In the step 168, it is judged whether or not a timing to start to open the cap of the replenisher cartridge 56 comes. When the result of judgment is NO, the judgment in the step 168 is repeated until the result of judgment becomes YES. When the result of judgment in the step 168 is YES, the procedure sifts to a step 170 and it is judged whether or not the door on the side surface of the photo processing device 10 opens. In a case in which the result of judgment is YES, the procedure shifts to a step 172 and it is requested to close the door by displaying a message to request the customer to close the opened door, and the procedure returns to the step 170.

When it is determined that the door is closed, the result of judgment in the step 170 becomes YES, the procedure shifts to a step 174, and an interlock mechanism provided corresponding to the door is activated to prevent the door from being opened carelessly. In a next step 176, the cartridge receiver 58A is moved downward by an up-and-down drive portion not shown. And in a step 178, it is judged whether or not the cartridge receiver 58A reaches the lower limit position. In a case in which the result of judgment is NO, the procedure returns to the step 176 and repeats the steps 176 and 178 until the result of judgment in the step 178 becomes YES. Thereby, the descending motion of the cartridge receiver 58A is continued until the cartridge receiver 58A reaches the lower limit position.

When a lower limit position detection sensor not shown detects that the cartridge receiver 58A reaches the lower limit position, the result of judgment in the step 178 becomes YES and the procedure shifts to a step 180. Along with an arrival of the cartridge receiver 58A to the lower limit position, the caps of the replenisher outlets of the replenisher cartridge 56 are opened by the opening nozzles 60, and the replenishers in each liquid chambers are discharged from the replenisher outlets and are guided and supplied to the corresponding replenisher tanks through the liquid receiver portion 58B, respectively. In the step 180, it is waited for a predetermined time period (for example, several tens of seconds) required until the total quantity of the replenisher enclosed in the replenisher cartridge 56 is discharged from the replenisher cartridge 56 and supplied to the replenisher tank.

A concentrated replenisher is enclosed in the replenisher cartridge 56 according to the embodiment such that one loading (replacement) of the replenisher cartridge 56 per week may suffice in a state in which the photo processing device 10 is operated normally. In a next step 182, dilute processing for diluting the replenisher supplied to the replenisher tank to a predetermined concentration is performed. The replenisher made a predetermined concentration in the dilute processing is appropriately supplied to the processing solution in each processing solution tank depending on the processing area of the photographic paper 12 in the photo processing device 10. And, the opening nozzle 60 is provided with a function to clean each liquid chamber and the cap of the replenisher cartridge 56, and in a step 184, each liquid chamber of the replenisher cartridge 56 is cleaned by the opening nozzle 60, and in a step 186, the opened cap is cleaned by the opening nozzle 60.

Once the cleaning processing in the steps 184 and 185 is completed, the cartridge receiver 58A is moved upwardly by the up-and-down drive portion not shown in a step 188. In a step 190, it is judged whether or not the cartridge receiver 58A arrives at the upper limit position. In a case in which the result of judgment is NO, the procedure returns to the step 188 and repeats the steps 188 and 190 until the result of judgment in the step 190 becomes YES. Thereby, the elevating motion of the cartridge receiver 58A is continued until the cartridge receiver 58A arrives at the upper limit position. When an upper limit position detection sensor not shown detects that the cartridge receiver 58A arrives at the upper limit position, the result of judgment in the step 190 becomes YES and the processing when loading cartridge is ended.

Meanwhile, in the above-described processing when loading cartridge, after activating the interlock mechanism in the step 174 the processing is ended without releasing the action, so that it is prevented that the door on the side portion of the photo processing device 10 is opened and the already loaded replenisher cartridge 56 is removed, until the new replenisher cartridge 56 is loaded in the cartridge loading portion 58. And, along with the loading of the new replenisher cartridge 56 in the photo processing device 10, the empty replenisher cartridge 56 removed from the photo processing device 10 is sent to a maintenance center by the customer. The empty replenisher cartridge 56 collected in the maintenance center is recycled as a resource or cleaned and reused as the replenisher cartridge.

### Second Embodiment

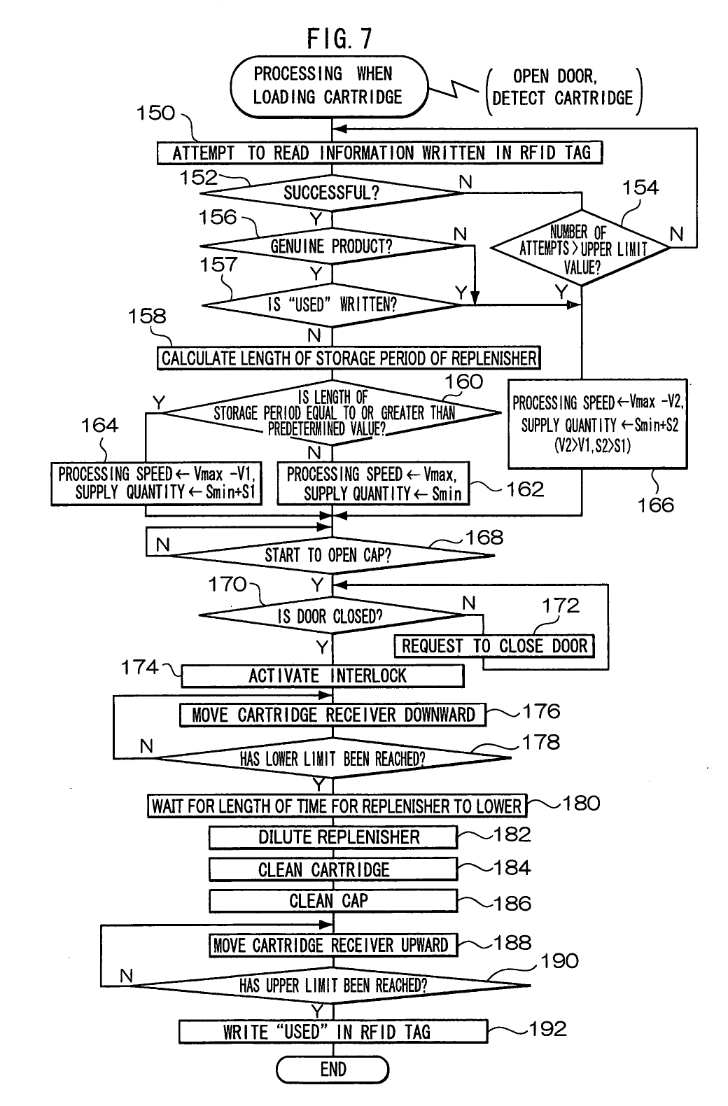

Next, a second embodiment of the present invention will be described. Meanwhile, a part of the processing in the second embodiment has the structure identical to that in the first embodiment, so that the same reference numeral is assigned to them and the description thereof is omitted. Hereinafter, with reference to FIG. 7, the processing when loading cartridge according to the second embodiment will be described only about a portion different from the processing when loading cartridge described in the first embodiment.

In the processing when loading the cartridge according to the second embodiment, after the replenisher enclosed in the replenisher cartridge 56 loaded in the cartridge loading portion 58 is supplied to each replenisher tank in steps 168 to 190, in a step 192, used information indicating that the replenisher cartridge 56 is already used is sent to the RFID tag 72 through the IC tag head 86, and the CPU 82 of the RFID tag 72 is indicated to write the sent information to the memory 84. Thereby, the used information is written in the memory 84 of the RFID tag 72. Meanwhile, the used information corresponds to third predetermined information described in Claims, and the step 192, together with the IC tag head 86, which actually sends the used information to the RFID tag 72 and causes the used information to be written in the memory 84, corresponds to a writing portion described in Claims.

In the second embodiment, if the type information read from the RFID tag 72 is identical to the genuine type information so that the result of judgment in the step 156 is YES, it is judged that whether or not the used information exists in the information read from the RFID tag 72 in the step 157. Meanwhile, the step 157 corresponds to the determination portion described in Claims. When the result of judgment is NO, it is determined that the replenisher cartridge 56 is the cartridge, which was not loaded in the photo processing device 10 in the past, so that the procedure shifts to a step 158 and the processing from the step 158 is performed as in the first embodiment.

On the other hand, when the result of judgment in the step 157 is YES, the replenisher cartridge 56 is determined to be the cartridge which is obtained by enclosing again the replenisher in the bottle of the genuine replenisher cartridge 56, or the cartridge to which the RFID tag 72 detached from the genuine replenisher cartridge 56, which was loaded in the past, is attached. The non-genuine replenisher is enclosed in the replenisher cartridge, and there may be a possible disadvantage that the photo processing performance is significantly reduced and the photo processing device 10 malfunctions, depending on the processing speed in the processor portion 24 and the supply quantity of each replenisher to each processing solution tank. Therefore, when the result of judgment in the step 157 is YES, the procedure shifts to the step 166 and the value obtained by subtracting the predetermined value V2 from the maximum speed Vmax is set as the processing speed V, and the value obtained by adding the predetermined value S2 to the minimum value Smin is set as the supply quantity S. Meanwhile, the step 166 in the second embodiment also corresponds to the control portion described in Claims.

Thereby, even when the replenisher cartridge 56 loaded this time in the cartridge loading portion 58 is the cartridge obtained by enclosing the replenisher in the bottle of the genuine replenisher cartridge 56, or the cartridge to which the RFID tag 72 detached from the genuine replenisher cartridge 56, which was loaded in the past, is attached, the operation of the photo processing device 10 is not stopped, and the replenisher enclosed in the replenisher cartridge 56 is supplied to the replenisher tank. In this case, the processing speed in the processor portion 24 is clearly (by the predetermined value V2) decreased from the maximum speed Vmax, and the supply quantity of each replenisher from each replenisher tank to each processing solution tank is clearly (by the supply quantity corresponding to the predetermined value S2) increased from the minimum supply quantity corresponding to the minimum value Smin. Thereby, it becomes possible to use so-called non-genuine replenisher cartridge when supplying the replenisher to the photo processing device 10, and the reduction in the photo processing performance, such as significant reduction in the image quality of the image recorded on the photographic paper 12, is prevented.

Meanwhile, although the mode in which the processing speed in the processor portion 24 and the supply quantity of each replenisher to each processing solution tank is changed depending on whether or not the replenisher cartridge 56 loaded in the cartridge loading portion 58 is genuine has been described in the above-described embodiment, an aspect of the present invention is not limited to this and only one of the processing speed and the supply quantity may be changed.

Further, in the first embodiment, although a mode has been described as an example in which, when the replenisher cartridge 56 loaded in the cartridge loading portion 58 is the genuine product, the processing speed and the supply quantity are changed in two steps depending on whether or not the predetermined time period or more has elapsed since the manufacture of the replenisher enclosed in the replenisher cartridge 56, the aspect of the present invention is not limited to this, and the processing speed and the supply quantity may be changed in many steps more than three steps depending on the time period that has elapsed since the manufacture of the replenisher, or the processing speed and the supply quantity may be continuously changed depending on the change in the elapsed time period.

In addition, in a case in which the predetermined time period has elapsed since the manufacture of the replenisher enclosed in the replenisher cartridge 56 loaded in the cartridge loading portion 58, a temperature of each processing solution in each processing solution tank may be increased, and increase in the liquid temperature and increase in the supply quantity of each replenisher to each processing solution tank may be combined, instead of the mode in which the processing speed in the processor portion 24 is decreased and the supply quantity of each replenisher to each processing solution tank is increased.

Furthermore, although the example in which the RFID tag, capable of reading and writing of the information by the radio transmission is applied as a recording device described in Claims has been described in each example, an aspect of the present invention is not limited to this and various types of recording devices, capable of reading and writing the information by the known method, such as the method utilizing magnetic, for example, may be applicable. However, when considering easily performing the reading and writing of the information, it is preferred to use the recording device capable of contact less reading and writing the information as the RFID tag. And an aspect of the present invention is not limited to the recording of the information to the recording device attached to the cartridge, and the information such as the first predetermined information according to an aspect of the present invention may be recorded in the cartridge in a form of a barcode or the like.

And although the supplying method in which when the new replenisher cartridge 56 is loaded in the cartridge loading portion 58, the total quantity of the replenisher enclosed in the loaded replenisher cartridge 56 is transferred to the replenisher tank has been described as the example, an aspect of the present invention is not limited to this and a supplying method to supply the replenisher directly from the cartridge loaded in the photo processing device to the processing solution in the processing solution tank, without providing the replenisher tank, may be adopted. In this case, considering the possibility in which the cartridge is attached to and detached from the photo processing device even in a state in which only a part of the replenisher originally enclosed is supplied to the processing solution tank, the writing of the used information to the recording device of the cartridge may be performed when the cartridge is empty and there is not a possibility that the cartridge is reloaded in the cartridge loading portion 58.

And, although the photo processing device provided with the exposure portion 18 for exposure-recording the image on the photographic paper by scan-exposing the photographic paper with a laser beam modulated depending on the image to be recorded has been described as the photo processing device according to an aspect of the present invention, an aspect of the present invention is not limited to this, and it goes without saying that an aspect of the present invention is applicable to the photo processing device (surface exposure-type printer processor) provided with the exposure portion of a type in which the image is exposure-recorded on the photographic paper by irradiating the photo film with the light, and irradiating the photographic paper with light transmitted through the photo film.

### INDUSTRIAL APPLICABILITY

In an aspect of the present invention, it is determined whether or not a predetermined information is recorded in a loaded replenisher cartridge, and when the predetermined information is not recorded and other predetermined information is recorded, at least one of a first control for decreasing a processing speed of a recording material, a second control for increasing a supply quantity of a replenisher to a processing solution tank, and a third control for changing a temperature of a processing solution in the processing solution tank. Thereby, a photo processing device in which a significant reduction in the photo processing performance is prevented from occurring, and with which both a genuine replenisher cartridge and non-genuine replenisher cartridge can be used, the cartridge used with the device, and a photo processing method are provided.

### DESCRIPTION OF REFERENCE NUMERALS

10 photo processing device
12 photographic paper
20 main body control portion
24 processor portion
26 color developer tank
28 bleach fixing agent tank
30, 32, 34, 36 rinse water tank
37 carrier motor
50 developer replenisher tank
52 bleach fixing agent replenisher tank
54 water tank
56 replenisher cartridge
58 cartridge loading portion
62, 64, 66 pump
68 electromagnetic valve
72 RFID tag
86 IC tag head

1. A photo processing device that processes a recording material on which an image is recorded by a processing solution in a processing solution tank, the device comprising:
a detachable cartridge enclosing a replenisher to be supplied to the processing solution in the processing solution tank;
a determination portion that determines whether or not first predetermined information is recorded at the cartridge; and
a control portion that, when the determination portion determines that the first predetermined information is not recorded at the cartridge, performs either or both of a first control that makes a processing speed of the recording material slower than when a cartridge is loaded at which the first predetermined information is recorded, and a second control that makes a supply quantity of the replenisher to the processing solution tank larger than when the cartridge is loaded at which the first predetermined information is recorded.

2. The photo processing device of claim 1, wherein the control portion performs either or both of the first control and the second control depending on a length of storage period of the replenisher, which is identified based on second predetermined information recorded at the cartridge by which the length of storage period of the replenisher enclosed can be identified.

3. The photo processing device of claim 1, wherein the cartridge is configured such that information may be written thereon,
the photo processing device is further provided with a writing portion for writing third predetermined information to the loaded cartridge,
the determination portion further determines whether or not the third predetermined information is recorded at the cartridge, and
the control portion performs either or both of the first control and the second control when the determination portion determines that the third predetermined information is recorded at the cartridge.

4. The photo processing device of claim 1, wherein the control portion further performs a third control that changes a temperature of the processing solution in the processing solution tank.

5. The photo processing device of claim 1, wherein the first predetermined information is recorded at a recording device attached to the cartridge, and
the determination portion is provided with a reading portion configured to read the information recorded at the recording device attached to the loaded cartridge, makes the reading portion read the information recorded at the recording device attached to the loaded cartridge, and determines whether or not the first predetermined information is recorded based on a result of the reading.

6. The photo processing device of claim 1, wherein the first control is selected from a plurality of predetermined processing speeds, and the second control is selected from a plurality of predetermined supply quantities of the replenisher.

7. The photo processing device of claim 4, wherein the first predetermined information is recorded at a recording device attached to the cartridge, and
the determination portion is provided with a reading portion configured to read the information recorded at the recording device attached to the loaded cartridge, makes the reading portion read the information recorded at the recording device attached to the loaded cartridge, and determines whether or not the first predetermined information is recorded based on a result of the reading.

8. The photo processing device of claim 5, wherein second predetermined information, by which a length of storage period of the replenisher enclosed in the cartridge can be identified, is recorded at the recording device attached to the cartridge when manufacturing the cartridge, when enclosing the replenisher in the cartridge, or when shipping the cartridge, and
the control portion performs either or both of the first control and the second control depending on the length of storage period of the replenisher, which is identified based on the second predetermined information read from the recording device attached to the loaded cartridge by the reading portion.

9. he photo processing device of claim 5, wherein the recording device attached to the cartridge is configured such that information may be written thereon,
the photo processing device is further provided with a writing portion for writing third predetermined information to the recording device attached to the loaded cartridge,
the determination portion further determines whether or not the third predetermined information is recorded at the recording device attached to the cartridge, and
the control portion performs either or both of the first control and the second control when the determination portion determines that the third predetermined information is recorded at the recording device of the cartridge.

10. The photo processing device of claim 7, wherein second predetermined information, by which a length of storage period of the replenisher enclosed in the cartridge can be identified, is recorded at the recording device attached to the cartridge when manufacturing the cartridge, when enclosing the replenisher in the cartridge, or when shipping the cartridge, and
the control portion performs either or both of the second control and the third control depending on the length of storage period of the replenisher, which is identified based on the second predetermined information read from the recording device attached to the loaded cartridge by the reading portion.

11. A cartridge that is configured to be loaded at the photo processing device of claim 1, in which cartridge the replenisher to be supplied to the processing solution in the processing solution tank is enclosed, and at which cartridge the first predetermined information is recorded in advance.

12. A cartridge that is configured to be loaded at the photo processing device of claim 1, in which cartridge the replenisher to be supplied to the processing solution in the processing solution tank is enclosed, and to which cartridge the recording device is attached.

13. A method for controlling a photo processing device for processing a recording material on which an image is recorded by a processing solution in a processing solution tank, comprising:
determining whether or not first predetermined information is recorded at a detachable cartridge in which a replenisher to be supplied to the processing solution in the processing solution tank is enclosed; and
when it is determined that the first predetermined information is not recorded at the cartridge, performing either or both of a first control that makes a processing speed of the recording material slower than when a cartridge is loaded at which the first predetermined information is recorded, and a second control that makes a supply quantity of the replenisher to the processing solution tank larger than when the cartridge is loaded at which the first predetermined information is recorded.

14. The method for controlling the photo processing device of claim 13, further comprising:
obtaining second predetermined information that is recorded at the cartridge, by which a length of storage period of the enclosed replenisher can be identified; and
performing either or both of the first control and the second control depending on the length of storage period of the replenisher, which is identified based on the obtained second predetermined information.

15. The method for controlling the photo processing device of claim 13, further comprising recording third predetermined information at the cartridge.

16. The method for controlling the photo processing device of claim 13, further comprising:
determining whether or not third predetermined information is recorded at the cartridge; and
performing either or both of the first control and the second control when it is determined that the third predetermined information is recorded at the cartridge.

17. The method for controlling the photo processing device of claim 13, further comprising:
obtaining second predetermined information that is recorded at the cartridge, by which a length of storage period of the enclosed replenisher can be identified; and
performing either or both of the second control and a third control that changes a temperature of the processing solution in the processing solution tank, depending on the length of storage period of the replenisher, which is identified based on the obtained second predetermined information.

18. The method for controlling the photo processing device of claim 13, wherein the first predetermined information is recorded at a recording device attached to the cartridge, and
the information recorded at the recording device attached to the loaded cartridge is read, and it is determined whether or not the first predetermined information is recorded, based on a result of the reading.

19. The method for controlling the photo processing device of claim 13, wherein the first control is selected from a plurality of predetermined processing speeds, and the second control is selected from a plurality of predetermined supply quantities of the replenisher.

20. The method for controlling the photo processing device of claim 14, wherein the second predetermined information is recorded at a recording device attached to the cartridge when manufacturing the cartridge, when enclosing the replenisher in the cartridge, or when shipping the cartridge, and
either or both of the first control and the second control is performed depending on the length of storage period of the replenisher, which is identified based on the second predetermined information in the recording device attached to the loaded cartridge.

21. The method for controlling the photo processing device of claim 16, wherein the third predetermined information is written at a recording device attached to the cartridge, and
either or both of the first control and the second control is performed when it is determined that the third predetermined information is recorded at the recording device of the cartridge.
